(19) United States
(12) Patent Application Publication
(10) Pub. No.: US 2025/0045651 A1
(43) Pub. Date: Feb. 6, 2025

(54) BAGGAGE DELIVERY SYSTEM AND METHOD

(71) Applicant: SITA Information Networking Computing UK Limited, Hayes (GB)

(72) Inventors: Pierre Marie Jean GUIOL, Geneva (CH); Adrien SANGLIER, Geneva (CH)

(21) Appl. No.: 18/802,899

(22) Filed: Aug. 13, 2024

Related U.S. Application Data
(63) Continuation of application No. 17/058,156, filed on Nov. 24, 2020, now abandoned.

(30) Foreign Application Priority Data
May 25, 2018 (GB) 1808633.0

(51) Int. Cl. G06Q 10/02; G06Q 10/083; G06Q 10/0833; G06Q 50/40

(52) U.S. Cl. CPC G06Q 10/025; G06Q 10/083; G06Q 10/0833; G06Q 50/40

(57) ABSTRACT

A system and method of delivering a bag to a final destination are described. The system receives a customer request to re-route the bag, the customer request including a final destination and a unique identifier associated with customer-related information. The system identifies the bag based on the customer-related information and re-routes the bag from a first destination to a further destination. The system sends a delivery request to a delivery service provider for the bag to be delivered from the further destination to the final destination.

### CROSS-REFERENCE TO RELATED APPLICATIONS

This application is a continuation of U.S. patent application Ser. No. 17/058,156, filed on Nov. 24, 2020 and entitled “BAGGAGE DELIVERY SYSTEM AND METHOD,” which is a national stage application, filed under 35 U.S.C. § 371, of International Patent Application No. PCT/EP2019/063246, filed on May 22, 2019, which claims the benefit of and priority of Great Britain Application No. GB 1808633.0, filed May 25, 2018, and entitled “BAGGAGE DELIVERY SYSTEM AND METHOD,” which are incorporated by reference herein in their entirety.

### FIELD OF INVENTION

The invention relates to a baggage delivery system and method, particularly for use at a transport hub or interchange, such as an airport.

### BACKGROUND

In the airline industry, regulations require items of baggage, such as bags and suitcases, exceeding certain size or weight limits to be checked into the hold of an aircraft during a flight. On arrival at the destination airport the passenger collects their checked articles of baggage, typically from a baggage carousel. However, the process of waiting for checked baggage to be delivered to the baggage carousel is tedious. Moreover, the passenger must transport their bags, which are often heavy and unwieldy, from the airport to their final destination. If, as is commonly the case, the passenger is unable or unwilling to travel straight to their final destination then the passenger must carry their baggage with them. It would be advantageous to provide a baggage delivery service which relieved passengers of the burden of carrying cumbersome items of baggage from the airport to a final destination, thereby freeing the passenger to pursue leisure or business activities in the meantime.

Some existing services enable baggage to be delivered to a final destination, however these services are inconvenient to use. This is because users are required to go to specific suppliers who may only provide a geographically limited service, a complex experience and/or a relatively expensive service (in excess of €50 per bag).

It would also be advantageous to provide a delivery service which delivers baggage to a final destination rather than a usual destination, for example an airport bag carrousel. Such systems would advantageously reduce the volume of baggage being delivered to the usual destination. For example, fewer bags may be provided to the carousel area, thereby reducing the number of passengers waiting their bags at the carousel area resulting in baggage reclaim requiring a smaller area within the airport terminal. Providing fewer bags to the carousel area could also advantageously enable the remaining bags to be delivered to the carousel in a more time efficient manner.

Any such system should enable third parties, such as courier companies like Uber™, Lyft™, FedEx™, local taxis or any other suitable means of delivery, to take responsibility for delivering the articles of baggage. Additionally, the system should be compatible with existing infrastructure, easy to use and have extensive coverage.

### SUMMARY OF INVENTION

The invention is defined by the independent claims, to which reference is now drawn. Preferable features are laid out in the dependent claims.

In a first aspect of the invention, a bag delivery system comprises a receiver for receiving customer-related information associated with the bag and a customer request to re-route the bag, the customer request including a final destination and a unique identifier associated with the customer-related information, a scanner for identifying the bag based on the customer-related information, a baggage sortation system for re-routing the bag from a first destination to a further destination, and a transmitter for sending a delivery request including the further destination and the final destination to a delivery service provider for the article to be delivered from the further destination to the final destination. In an embodiment of the invention, the customer is a passenger.

In another embodiment of the invention, the customer-related information is associated with the bag during check in.

In another embodiment of the invention, the customer-related information includes a customer name, a passenger name record (PNR) and/or a licence plate number (LPN).

In another embodiment of the invention, the baggage sortation system is a baggage reconciliation system.

In another embodiment of the invention, a notification including the customer-related information is sent to the baggage reconciliation system to perform re-routing of the article from the first destination to the further destination.

An embodiment of the invention further comprises a bag tracking service for providing bag location information

In another embodiment of the invention, the bag tracking service is a flight tracker or a baggage tracker.

In another embodiment of the invention, the scanner is an optical scanner.

In another embodiment of the invention, the delivery request further includes a collection time for the delivery service provider to collect the bag for delivery.

In another embodiment of the invention, a delivery service confirmation request is also sent by the transmitter.

In another embodiment of the invention, a unique service availability identifier is received by the receiver in response to the delivery service confirmation request.

In another embodiment of the invention, the unique identifier is the unique service availability identifier.

An embodiment of the invention further comprises a notifier for notifying the customer that the bag has been delivered to the final destination.

In a second aspect of the invention, a bag delivery method comprises receiving customer-related information associated with the bag, receiving a customer request to re-route the bag, the customer request including a final destination and a unique identifier associated with the customer-related information, identifying the bag with a scanner based on the customer-related information, re-routing the bag from a first destination to a further destination, and sending a delivery request including the further destination and the final destination to a delivery service provider for the bag to be delivered from the further destination to the final destination.

In an embodiment of the invention, the customer is a passenger.

In another embodiment of the invention, the customer-related information is associated with the bag during check in.

In another embodiment of the invention, the customer-related information includes a customer name, a passenger name record (PNR) and/or a licence plate number (LPN).

In another embodiment of the invention, the delivery request further includes a collection time for the delivery service provider to collect the bag for delivery.

An embodiment of the invention further comprises the step of sending a delivery service confirmation request.

An embodiment of the invention further comprises the step of receiving a unique service availability identifier in response to the delivery service confirmation request.

In another embodiment of the invention, the unique identifier is the unique service availability identifier.

An embodiment of the invention further comprises the step of notifying the customer that the bag has been delivered to the final destination.

In another embodiment of the invention, the step of re-routing the bag from a first destination to a further destination comprises sending a notification to a bag reconciliation system.

In another embodiment of the invention, the notification includes the customer-related information.

An embodiment of the invention further comprises the step of receiving bag location information from a bag tracking service

An embodiment of the invention further comprises the step of notifying the delivery company with the bag location information.

### DETAILED DESCRIPTION

Embodiments of the invention will now be described, by way of example only, with reference to the accompanying drawings, in which:

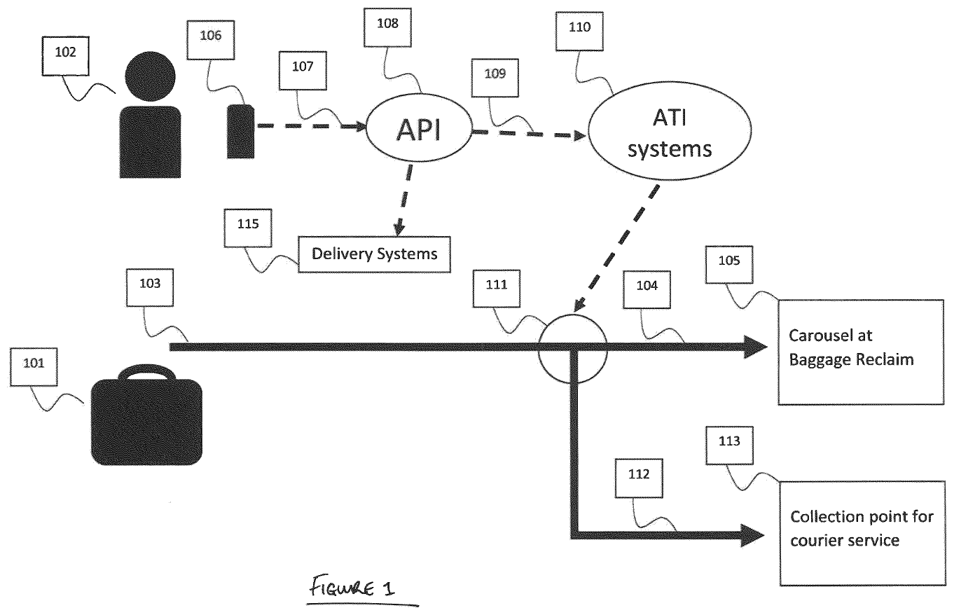

FIG. 1 shows a schematic diagram of a bag delivery system embodying the invention;

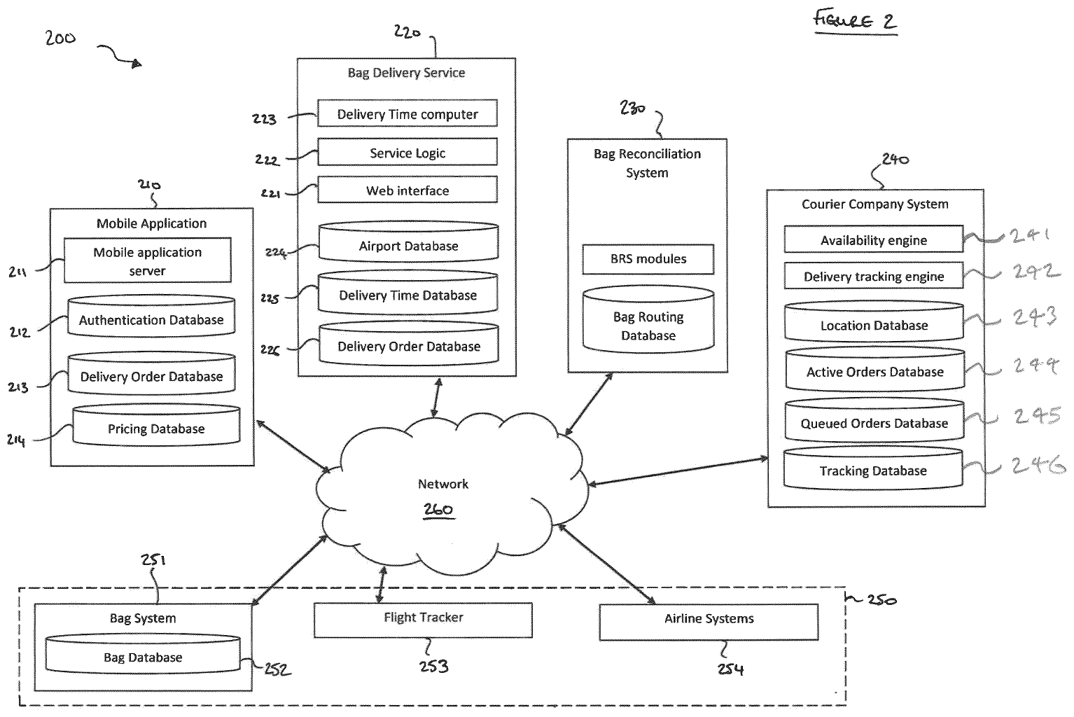

FIG. 2 shows a schematic block diagram of a bag delivery system architecture embodying the invention;

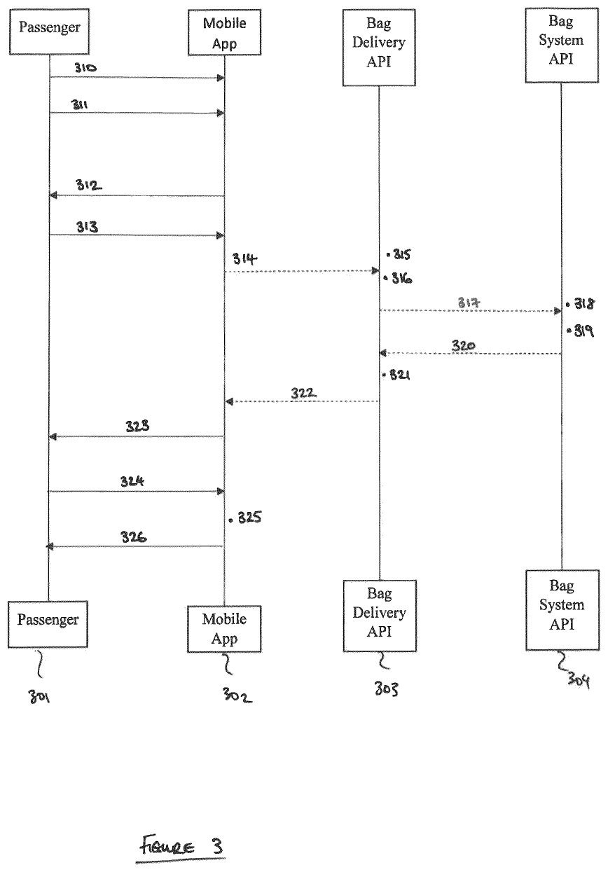

FIG. 3 shows a flow diagram of an example process for determining the service availability of a bag delivery service; and

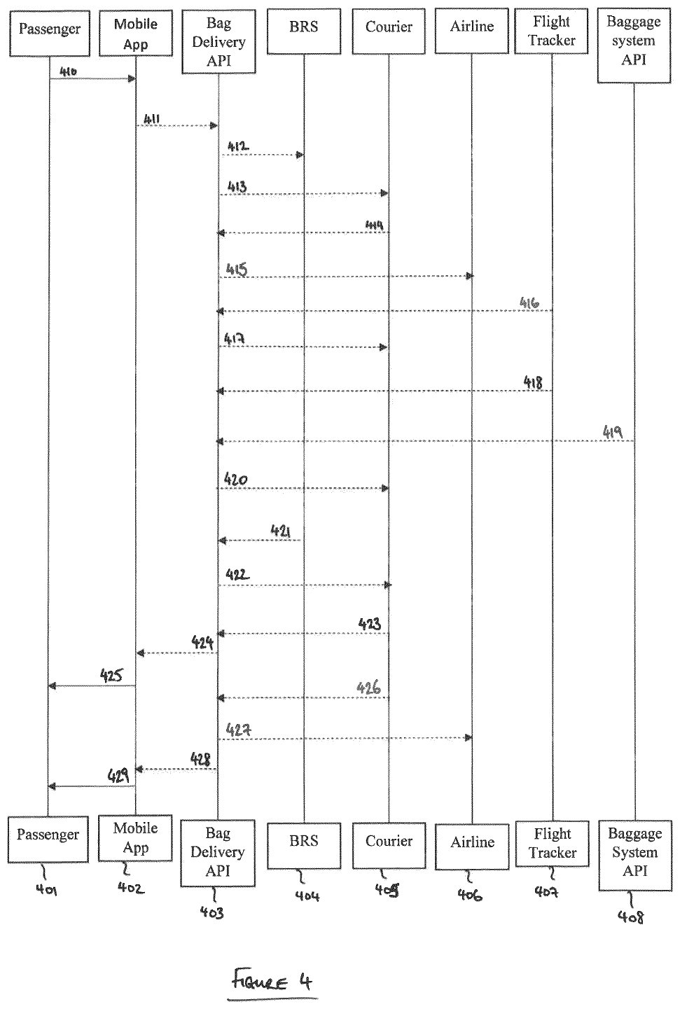

FIG. 4 shows a flow diagram of an example process for ordering a bag delivery service.

The specific embodiments of the invention described below relate to items of baggage, such as bags and suitcases. However, in the Air Transport Industry (ATI), any items, articles or containers which are to be placed in the hold of an aircraft for transportation must first be checked in. During the check in process, a bag tag containing passenger-and flight-related information is associated with the checked article and the article is processed by ATI systems in the same way as a checked bag or suitcase. For the purposes of the below description, it will therefore be understood that the terms “baggage” or “bag” may include any article for storage in the hold of an aircraft during transportation.

Checked bags, once unloaded from an aircraft hold, may be handled in a variety of ways. If a bag is to be transferred onto a connecting flight, the bag may be handled by an ATI baggage handling system (BHS) which provides further sortation of the bag. Alternatively, the checked bag is provided to an ATI baggage reconciliation system (BRS) for delivery to a bag carousel at baggage reclaim for passengers to collect. However, it will be appreciated that where the above systems are unavailable the bags may be manually sorted and handled. In the following description, it is described how the Bag Reconciliation System (BHS), 230 may comprise one or more BRS modules and a Bag Routing Database. However, it will be appreciated that The Bag Reconciliation System may be replaced by a Bag Handling System (BHS). The Bag handling system may comprise one or more bag handling modules and a bag routing database. Thus, it will be appreciated that the functionality of the bag reconciliation system may be replaced by that of a bag handling system. Messages may be distributed to a Bag Handling System using an intermediary message brokering system.

They system may also be configured to flag a bag, which is “subscribed” to ground delivery at destination airport, by sending a specific mark or message to the BHS, through a Bag Message broker. This may allow the bag to be collected or routed on to a specific area, rather than to the arrival carrousel in the arrival hall.

To ameliorate the amount of time that a passenger spends waiting to be reunited with their bags at baggage reclaim, aspects of the invention enable a passenger to request that the BRS deliver their bag to a separate location where it may be collected by a courier and delivered to a final destination chosen by the passenger, as further described below with reference to FIG. 1.

FIG. 1 shows a high level overview of an embodiment of the invention.

A bag 101 belonging to a user 102 arrives at a destination airport and is unloaded at point 103. According to normal protocol, the BRS would deliver the bag 101 via path 104 to the correct bag carousel at baggage reclaim 105. However, the user 102 may decide to request their bag 101 is delivered to an alternative destination instead.

As shown in FIG. 1, a user 102 may send a delivery request 107 to a server such as an API server 108 via an application 106 located on a mobile device. The delivery request 107 may include passenger-related information associated with the bag 101. The API 108 may communicate with various ATI systems 110 by messages 109 in order to allow the ATI systems 110 to correctly identify the bag 101 at a triage point 111. The correct bag 101 may be identified based on the passenger-related information obtained from the delivery request 107. For example, the information obtained from the delivery request 107 may be cross referenced against information extracted from an identifier associated with the bag 101, such as a paper bag tag issued on check in. Once identified, the bag 101 is re-routed to an alternative destination. For example, in FIG. 1 the bag 101 is sent down alternate path 112 to a collection point 113 rather than down the usual path 104 to a baggage reclaim carousel 105. The API 108 may send delivery requests 114 to a delivery service provider 115 requesting the bag 101 is delivered from the collection point 113 to a final delivery destination chosen by the user. In some embodiments the delivery destination is also included in the delivery request 107.

In ATI applications, the API may communicate by API calls in REST/JSON format or alternatively may be transformed into Teletype baggage messages such as BIMs (Baggage Information Messages), BPMs (Baggage Processing Messages) or BSMs (Baggage Sortation Messages) to conform with legacy ATI systems.

FIG. 2 illustrates an example system architecture 200 for providing an article delivery system according to an embodiment of the invention, including a mobile application 210, a bag delivery service 220, an ATI baggage reconciliation system (BRS) 230, a courier company system 240 and ancillary systems 250. In some embodiments, the ancillary systems 250 include one or more of a baggage system 251 including a bag database 252, a flight tracker 253 and an airline system 254.

Each of the above systems may communicate by sending messages via a network 260 by any suitable means. For example, in some embodiments each of the systems described below may provide an API for communicating with other services via network 260. The API may be any suitable type of API, such as Simple Object Access Protocol (SOAP), Remote Procedure Call (RPC) or Representation State Transfer (REST). In the examples described below, communication is via API messages, however the inventive concept is not limited to such means of communication and, as will be appreciated by persons skilled in the art, the messages and notifications may be via any suitable data exchange format such as XML, RDF, YAML, REST, JSON, or Teletype format. In some embodiments different systems use different messaging formats, for example the mobile application may communicate in JSON format whereas ATI legacy systems may communicated in Teletype format. In such embodiments, it is well known to use a message converter to convert a first message format into a second message format.

In some embodiments, the mobile application 210 comprises, a mobile application interface running on the mobile phone of the passenger, a mobile application server 211, an authentication database 212 hosted on the mobile application server, a delivery order database 213 and a pricing database 214 that are hosted on the mobile application server. The application server 211 may execute activities performed by the mobile application, such as processing requests and notifications sent and received by the mobile application. The authentication database 212 may store identity information for authenticating the unique identity of the user. For example, the mobile application may store the name and passport number of the user. This allows the service to guarantee that only the owner of the bag can request the bag delivery service. The delivery order database 213 may store information related to requests for the bag delivery service made by users of the mobile application 210. Finally, the pricing database 214 may store information relating to the price of the service and may account for different factors which affect the price of the service. For example, the distance to the delivery destination may affect the price of the service.

In some embodiments, the mobile application 210 is a third-party application which may be provided by ATI companies, such as airlines or ATI service providers that want to offer the bag delivery service. In other embodiments, the mobile application 210 may be not be provided by ATI companies but courier companies instead. Thus, in embodiments of the invention, the mobile application may be provided by companies such as Uber™, Lyft™, AirFrance™ App, AMEX™, Triplt™, Concur™, and/or SkyScanner™ in addition to airports, airlines, ground handlers, airline alliance, travel agents, online travel agents, ride hailing companies, taxi companies and any other suitable company.

It will be appreciated that the mobile application 210 is not essential for providing a bag delivery system or for ordering a bag delivery service. For example, in some embodiments, the mobile application 210 is replaced by an ordering system integrated in the airline system in case the service is provided by the airline. In other embodiments, the mobile application 210 is replaced by a booking application which is provided by a travel reservation system provided by an online travel agent, travel agent or travel management company.

In some embodiments, the mobile application 210 may perform authentication steps to authenticate the identity of a user. For example, the mobile application 210 may perform known “Know Your Customer” (KYC) protocols for identifying and verifying the identity of the user. Authorisation to request the delivery service may be subsequently granted based on the user inputting data, for example by inputting biometric data or passport details which are cross-referenced against the data stored during the KYC protocols.

In other embodiments of the invention, the mobile application 210 may also include a database for holding payment data to enable a user to pay for the services provided. For example, a passenger may pay for a bag delivery service using a loyalty points scheme, such as their frequent flier miles.

It will be appreciated that the mobile application 210 may be implemented on a mobile device, such as a laptop computer, a tablet computer, a personal digital assistant, a mobile telephone, or a smartphone.

The bag delivery service 220 may comprise a web interface 221, service logic 222, a delivery time computer 223, an airport database 224, a delivery time database 225 and a delivery order database 226.

The web interface 221 enables the bag delivery service 220 to be managed and serviced via a support web page. The service logic 222 may comprise a computer processor for running one or more computer readable program instructions to enable an API to provide a bag delivery service. Likewise, the delivery time computer 223 may comprise a computer processor for calculating a time for a selected bag to be delivered to a nominated destination. The computer readable program instructions above may be source code or object code written in or in any combination of suitable programming languages including procedural programming languages such as C, object orientated programming languages such as C #, C++, Java, scripting languages, assembly languages, machine code instructions, instruction-set-architecture (ISA) instructions, and state-setting data.

The airport database 224 may store a list of airports which are able to provide the bag delivery service. In addition, the airport database 224 may also store ancillary information related to each airport. For example, the airport database 224 may store location information, such as GPS coordinates, for each airport listed in the database. The delivery time database 225 may store a number of parameters to enable the bag delivery service 220 to estimate a bag delivery time. For example, the stored parameters may account for how differences in weather, time and/or flight operator may affect the delivery time of the bag. In some embodiments, the delivery time database 225 stores a record of how long it took to deliver a bag to enable the bag delivery service to predict how long a delivery will take based on known machine learning techniques. Finally, the delivery order database 226 may store information related to requests for the bag delivery service as described above.

The BRS 230 may comprise various BRS modules 231 and a bag routing database 232, and other. Examples of other BRS modules 231 may include any suitable system for transporting a bag such as scanning systems, conveying systems and monitoring systems. The bag routing database 232 may include the scheduled destination and route associated with a bag.

In usual operation, the BRS 230 ensures baggage arriving on a flight is delivered to the correct carrousel for collection by passengers. ATI standards mandate scanning bags at key points in the bag journey, for example when receiving a bag from the passenger, when loading the bag onto an aircraft, and when returning the bag to the passenger. Accordingly, bags will typically be scanned by the BRS 230 before being delivered to the collection carousel.

In embodiments of the invention, the BRS 230 receives bag routing messages from the bag delivery service 220 and stores bag routing data obtained from those messages in the bag routing database 232. The BRS 230 ensures the bag is re-routed to the collection location based on the data contained in the bag routing messages. For example, in specific embodiments the BRS 230 may cross-reference data contained in the routing messages against data obtained from the BRS 230 scanning the bag or a bag tag associated with the bag prior to being delivered to the collection carousel. If the data contained in a routing message matches the scanned data obtained from a bag, the BRS 230 flags the bag for re-routing to an alternative pick-up location for delivery by a courier company.

The courier company system 240 may comprise an availability engine 241, a delivery tracking engine 242, a location database 243, an active orders database 244, a queued orders database 245 and a tracking database 246.

The availability engine 241 may determine whether the courier company is able to provide the bag delivery service. In some embodiments, the service availability is determined based on the number of queued orders stored in the queued order database 245. Additionally, the service availability may be determined based on the time of day and/or the number of locations stored in the location database 243. The delivery tracking engine 242 may determine in real time the current status of each active bag delivery order. In some embodiments, the delivery status of an order may be determined based on data stored in the tracking database 246.

The location database 243 may store a list of locations that the courier is able to deliver to. For example, the location database 243 may store a list of local zip codes or post codes within an acceptable delivery radius. The active orders database 244 may store a list of all the orders which have been accepted but have not yet been delivered. The queued orders database 245 may store a list of the orders which have not yet been accepted and which are waiting for approval by the availability engine 241. Finally, the tracking database 246 may store tracking data related to the last known location of a bag which is being delivered. In some embodiments, the tracking database 246 may also store tracking data related to the last known location of each of a plurality of delivery vehicles. The Courier Company can be any company that has an agreement with the airport to provide delivery of bags from pickup location to the final destination. In some embodiments, the Courier Company can be affiliated with an ATI company, such as the destination airport or an individual airline. In other embodiments the Courier Company may not be affiliated with an ATI company. For example, the Courier Company could be Uber, Lyft, FedEx, UPS, or a taxi company.

The Courier Company must be able to receive messages and to distribute those messages to drivers. In preferred embodiments, the Courier Company provides a Courier Company Service which communicates via API requests. In some embodiments, the courier company can pool the delivery of multiple bags.

A bag system 251 may provide the real time status of a bag, a list of bags on a particular flight, or a list of events detailing a bag journey. An open source bag system API may be found at https://www.developer.aero/BagJourney-API/API-Overview The bag system 251 may also include a bag database 252 for storing bag-related information for each item of checked baggage.

A flight tracker 253 may provide notifications and updates for a particular flight based on flight tracking provided by the Federal Aviation Administration (FAA). Several open source flight tracking API services are available, for example FlightXML 2.0 provided by Flight Aware and available at https://uk.flightaware.com/commercial/flightxml.

Airline systems 254 may store data relating to checked baggage, for example by sending the data to bag database 252. Airline systems 254 may be updated with a bag delivery status. As the airline is liable for the safe return of a bag to a passenger the airline is notified when the bag has been delivered to the correct destination or handed off to the Courier Company which in turns take the liability for the final delivery of the bag.

The above systems may communicate via a network 260. The network 260 may be a public, private, wired or wireless network. The network may include one or more of a local area network (LAN), a wide area network (WAN), the Internet, a mobile telephony communication system, or a satellite communication system.

The operation of bag delivery service 211 is described in more detail below with reference to the example workflows shown in FIGS. 3 and 4, whereby a passenger initially checks the service availability and then proceeds to order the service. For the sake of simplicity, error cases are not represented in the below workflows.

FIG. 3 illustrates a first example workflow showing the preliminary checks performed by an embodiment of the invention before the passenger orders the service to ensure the service can be effectively provided.

On closer inspection, it will be appreciated that FIG. 3 shows an example diagram representing the messages and process steps for a passenger 301 who checks in an item of baggage and wishes to determine whether the bag delivery service is available at their destination airport, Barcelona, using a mobile application 302.

The mobile application 302 is able to query existing airport legacy systems to provide bag details and the service availability for a given passenger and airport destination via a Bag Delivery Service 303. In an embodiment, the mobile application 302 is able to return the service availability, destination airport, number and weight (kg) of bags, flight information and a Service_Availability_ID to the passenger 301, wherein the Service_Availability_ID is a unique reference that may be used to confirm ordering the delivery service.

To begin the availability request, the passenger 301 starts the mobile application in step 310 and selects the bag delivery service in step 311. The mobile application 302 requests the passenger 301 takes a picture of their bag receipt in step 312, including the data recorded on the bag receipt. In addition, the passenger 301 must confirm their full name. Optionally, the mobile application 302 may confirm the passenger's authenticity, as described above using, for example, biometric data or a passcode.

Once the passenger 301 has provided a picture of their bag receipt in step 313, the mobile application 302 then sends a Service_Availability request 314 to the Bag Delivery Service 303 including the bag tag receipt data from the picture and the full passenger name, which may be from passenger authorisation or manually entered by the passenger.

An example service availability request is provided below as a uniform resource identifier (URI).
Service Availability request:
https://virtserver.swaggerhub.com/1.0.0/Ground_Bag_Delivery/Service_Availability?Passen ger_First_Name=John&Passenger_Last_Name=Doo&Bag_Receipt_Picture=picture_of_the _bag_receipt

The above example URI contains a character string used to identify a resource and includes data associated with a scheme, an authority, a system path, and a query. In the specific example shown in the above example, the scheme is a secure Hyper Text Transfer Protocol (HTTPS). The authority includes details of the host server or web address. In the above example, the authority is the web server address: “virtserver.swaggerhub.com.” The system path is a hierarchical structure of segments which allows the request to be handled by the appropriate part of the host server or web address. In the above example, the path defines the name of the service being requested “Ground Bag Delivery”, the version of the service, “1.0.0”, and the type of request, “Service Availability.” Finally, the query contains a string of data relating to the request. In the above example, “&” represents a delimiter and so the query includes: Passenger First Name, “John”; Passenger Last Name, “Doo”; and Bag Receipt Picture, which would provide a picture of the passenger's bag tag receipt.

The Bag Delivery Service 303 extracts passenger related data from the bag tag receipt in step 317. For example, the Bag Delivery Service 303 may extract passenger name data, Passenger Name Record (PNR) data, flight data, and bag Licence Plate Number (LPN) data from the bag tag by optical character recognition (OCR). Once extracted, the data may be stored in a database such as the delivery order database 226. The Bag Delivery Service 303 then performs verification checks in step 316 based on the extracted passenger related data. For example, the Bag Delivery Service 303 may verify whether the mobile application user's name included in the availability request matches the name extracted from the bag receipt. Additionally, the Bag Delivery Service 303 may establish whether the destination airport can provide the requested service and whether the relevant airline has approved the requested service for use by, for example, consulting data associated with the requested destination airport and airline in a database such as the airport database 224.

The Bag Delivery Service 303 then sends a Bag_Status request 317 to a bag system 304 to search a Bag Database 252 for bag details corresponding to the PNR obtained from the bag tag receipt. The PNR, along with other passenger and bag related information, will have been recorded in the Bag Database 252 during check in.

In step 318 the bag system API 304 performs a search of data related to stored baggage, for example by searching bag database 252 for a record matching the extracted passenger related data. If a matching bag record exists, the bag system API 304 retrieves the corresponding bag information from the database in step 319. The retrieved bag information may include the total number of checked bags, the total weight of bags, and flight information. In the example shown in FIG. 3, the retrieved bag information includes:
Bag LPN: 123456
Flight: U21401
Bag weight: 18 kg
Destination: BCN.

The bag system API 304 then returns the bag details as an API response 320 to the Bag Delivery Service API 303. The Bag Delivery Service API 303 checks that the retrieved information associated with the PNR corresponds to the data obtained from the bag tag receipt in step 321 and, if so, the Bag Delivery Service API sends a Service_availability API response 322 to the mobile application. In one embodiment, the API response 322 notifies the mobile application 302 that the bag delivery service is available to the passenger 301. In some embodiments, API response 322 includes a Service_Availability_ID for identifying a service availability request and information related to the service availability request.

An example service availability response including the retrieved bag status data for FIG. 3 may be as follows:

```
Service Availability response:
{
  “Service_available_at_airport”: true,
  “Service_Availability_ID”: 123123123,
  “Destination_Airport”: “BCN”,
  “Bag_Weight_kg”: 20,
  “Estimated_Bag_Arrival_Date_and_Time”: 1523699738,
  “Flight_Number”: “U21401”
}
```

In the above example, the API response provides the following data: the requested service is available for order; a Service Availability ID, “123123123”; the destination airport, which in the above example is Barcelona; the bag weight in kilograms, “20”; the estimated date and time of arrival as a UNIX timecode, which in the above example is 14 Apr. 2018, 9.55 am UTC; and finally the flight number, “U21401”.

The mobile application displays a notification 323 to the user that the delivery service is available and requests the user enter the final destination of their bag. The mobile application may also store the Service Availability ID for later use if the user decides to order the service.

Once the final destination is entered by the passenger in step 324, the mobile application calculates the price of bag delivery in step 325. In an embodiment, the bag delivery price may be calculated by looking up the correct price in the pricing database 214 according to factors such as the distance to the final destination, delivery service availability, and the number and weight of bags being delivered. In one embodiment, the price of bag delivery is calculated according to dynamic pricing, whereby the price of a service varies in accordance with the current demand for the service.

In an alternative embodiment, the mobile application 302 may also communicate with a courier company to verify the availability and price of service based on the requested time and destination etc.

In an alternative embodiment, if the mobile application 302 is replaced by a booking engine provided, for example, by a travel management company, the final destination can be automatically provided by this booking engine since the details of the final destination, such as the address of the hotel booked by the passenger, will be held by the same travel management company boking engine.

Finally, the mobile application displays the price of the service to the customer in step 326.

FIG. 4 illustrates a second example workflow showing the process if the passenger wishes to confirm ordering the bag delivery service. FIG. 4 shows an example diagram representing the process steps according to an embodiment of the invention performed by a mobile application 402 and bag delivery API 403 when communicating with a passenger 401, a bag reconciliation system 403, a courier delivery system 405, an airline system 406, a flight tracker 407 and a baggage system API 408.

In a first step the passenger 401 sends a confirmation to order the bag delivery service 410 via the mobile application 402. In response to the passenger confirmation 410, the mobile application 402 sends Service_Order API request 411 to the Bag Delivery Service API 403. This request may include the Service_Availability_ID previously provided to the mobile application 402 by the Bag Delivery Service API 403 during the service availability enquiry described above. The Service_Availability_ID is associated with bag information retrieved during the service enquiry process. For example, the bag information may include the bag LPN number, the flight number, the bag weight and the destination airport of the bag and may be stored on a database such as delivery order database 226. The Service_Availability_ID may also be associated with the final destination for the bag.

An example Service Order request is provided below as a uniform resource identifier (URI).
Service Order request:
https://virtserver.swaggerhub.com/1.0.0/Ground_Bag_Delivery/Service_Order?Final_Desti nation_Address=20Le % 20Meridien%2C%La%20Rambla%2C%20111%2C%2008002%20 Barcelona%2C%20Spain&Service_Availability_ID=123123123

As before, the above URI contains a character string used to identify a resource and may include data associated with a scheme, an authority, a system path, and a query. The scheme and authority are unchanged from the Service Availability request detailed above. The system path is mostly unchanged, but refers to a Service Order request rather than a Service Availability request. The query of the above example includes data relating to the final destination address and the earlier issued Service Availability ID, “123123123”. The query data string of the above example uses “%” as a delimiter, “20” to indicate separate strings within the address, and “2C” to indicate a new address line. Accordingly, the final destination that the bag should be delivered to is: “Le Meridien, La Rambla, 111, 08002 Barcelona, Spain.”

The Bag Delivery Service API 403 includes the bag LPN number in a number of requests to order the bag delivery service. In one embodiment, the Bag Delivery Service API 403 identifies the bag LPN from a local database such as delivery order database 226 based on the Service_Availability_ID. As above, the Bag Delivery Service API 403 requests may be messages in one of a variety of formats, for example REST/JSON format for communicating with other APIs or Teletype format for communicating with legacy systems.

In an embodiment, the Bag Delivery Service API 403 sends a BRS_Order API request 412 to a Baggage Reconciliation System (BRS) 404 notifying the BRS 404 that the bag associated with a particular LPN, for example LPN “123456”, should be routed to an alternative collection point, such as collection point 113. The Bag Delivery Service API 403 may also send a Courier_Order API request 413 to the Courier Company System 405 of at least one courier delivery company.

An example Courier Order request is shown below.
Courier Order request
curl-X POST
“https://virtserver.swaggerhub.com/1. 0. 0/Courier_Company/Courier_Order”-H “accept:*/*”-H“Content-Type: application/json”-d {“Bag_License_Plate_Number”: 123456, “Pickup_Location_in_Airport”:“BCN_Termi nal_1”, “Airport”:“BCN”, “Order_ID”:123123, “Passenger_First_Name”:“John”, “Pa ssenger_Last_Name”:“Doo”, “Estimated_Bag_Collection_Time”: 1523719365, “Final_Destination_Address”:“Le Meridien, La Rambla, 111, 08002 Barcelona, Spain”}

Similarly to previous requests, the Courier Order request includes the URI for requesting the courier order. In addition, the request includes data associated with the bag to be collected and the final destination delivery details.

In the specific example above, the request includes: the licence plate number of the bag for collection, in this case “123456”; the pick-up location, which in the above example is located in Terminal 1 of Barcelona Airport; the Service Order ID, “123123”; the passenger's name, “John Doo”; the estimated bag collection time as a UNIX timecode, which in the above example is 14 Apr. 2018, 3:22 pm UTC; and the final destination address, “Le Meridien, La Rambla, 111, 08002 Barcelona, Spain”.

In some embodiments, the estimated collection time may be calculated based on the scheduled or estimated flight arrival time in combination with an estimated delivery time for the airport to deliver the bag to the collection point. In such embodiments, the Bag Delivery Service 220 may store the scheduled and estimated times in a database, such as delivery time database 225. In an alternative embodiment, the estimated delivery time may be based on live tracking data stored in a database of the Baggage System 408, such as Bag Database 252.

In response to receiving the Courier_Order request, the Courier Company System 405 may send a notification 414 to the Bag Delivery Service API 403 confirming whether they are able to provide the bag delivery service. A confirmatory notification is shown in the example response below.
Courier Order Response:
status: 200, 200 OK

The data received from the Courier_Order request may be stored in the Active Orders Database 244 or the Queued Orders Database 245 depending on whether the Courier Company is able to provide the service.

Finally, the Bag Delivery Service API 403 also sends a Bag_Tracking_System_Update_Receiver API request 415 to the Airline System 406 of the airline responsible for the passenger's bag, notifying the airline that the specified bag will be re-routed to be collected by a courier company at the destination airport.

Once the delivery service requests 412, 413, 415 have been sent, the Bag Delivery Service API waits for flight information updates to be provided by a Flight Tracking System 407. For example, the Flight Tracking System 407 may send a notification 416 to the Bag Delivery Service API 403 including flight information related to the passenger's flight number. Accordingly, the Bag Delivery API 403 is provided with updated flight information which may be stored in a database such as the delivery time database 225. In response to the flight information update, the Bag Delivery Service API 403 sends a collection time update Courier_Order_Update API notification 417 to the Courier Company System 405, in this case notifying the courier of the new estimated collection time. For instance, in the example provided above the estimated collection time may be revised from 3:22 pm UTC to 3.35 pm UTC.

The Flight Tracker System 407 sends a confirmation that the flight the passenger is travelling on has landed in a further notification 418 to the Bag Delivery Service API 403. In some embodiments, the Baggage System API 408 may send a message 419 notifying the Bag Delivery Service API 403 that the bag has been unloaded from the plane. In some embodiments this may be performed by scanning the LPN of the bag tag once the bag is unloaded.

On receipt of the landing confirmation notification 418 and/or the bag unload notification 419, the Bag Delivery Service API 403 sends an updated estimated collection time as Courier_Order_Update API notification 420 to the Courier Company System 405. As described above, the estimated collection time may be based on an estimated delivery time for the airport to deliver the bag to the collection point, or alternatively based on bag tracking data.

When the bag has been correctly delivered to the collection point, the BRS 404 sends a BRS_Update API notification 421 to the Bag Delivery Service API 403. For example, the BRS_Update notifies the Bag Delivery Service API 403 that bag associated with the LPN 123456 is available for pick up at the alternative collection point. In response, the Bag Delivery Service API 403 sends a further Courier_Order_Update API notification 422 to the Courier Company System 405 notifying the courier company that the bag is ready for collection.

Once the courier has collected the bag, a notification is sent to the Bag Delivery Service API 403 as Courier_Update API notification 423. The notification 423 confirms that the bag has been collected. In some embodiments, the notification 423 may also include an estimated delivery time from the collection location to the final destination. For example, the estimated time of delivery may be 6:13 pm UTC. The estimated delivery time may be based upon a calculated arrival time determined by an open source journey planning API, for example the Google Maps Directions API. The Bag Delivery Service API 403 forwards the courier's estimated delivery time to the mobile application as App_Order_Update API notification 424. In an embodiment, the notification 424 includes confirmation that the passenger's bag has been collected and also includes an estimated delivery time at the final destination.

Having received the App_Order_Update API notification 424, the mobile application displays a notification 425 to the passenger including the details provided by the API notification 424. For example, the mobile application displays a notification stating: “Your bag will be delivered at 6:13 pm. Enjoy your day!”

Once the courier confirms that the passenger's bag is delivered to the final destination, the Courier Company System 405 sends a Courier_Update API notification 426 to the Bag Delivery Service API 403. In an embodiment, the Bag Delivery Service API 403 sends Bag_Tracking_System_Update_Receiver API notification 427 to the Airline System 406. In a similar manner as above, the Bag Delivery Service API 403 forwards the information included in API notification 426 to the mobile application as App_Order_Update API notification 428 confirming the exact delivery time. In turn, the mobile application displays a notification 429 to the passenger 401 confirming the bag was delivered. For example, the notification may state: “Your bag was delivered!”

Although not described in detail above, it will be appreciated that further messages may be exchanged in order to communicate the exact progress of the bag to the passenger in greater detail. For example, if the courier unexpectedly encounters traffic enroute to the final destination then the Courier Company System 405 may sent a message to the Bag Delivery Service API 403 detailing the delay and providing a new estimated delivery time at the final destination.

The destination airport is also referred to as a first terminal location. The origin airport is also referred to as a further terminal location. As will be described in further detail below, rather than sending a bag to a first destination, such as the carousel at baggage reclaim, a bag may be diverted to a further destination, such as a collection point for a courier service. The bag is collected from this further destination, and delivered to a final destination, as previously described.

In some embodiments, the passenger 301 may request that the passenger's bag be picked up from a location that is separate from the airport, prior to the flight. This allows the passenger's bag to be delivered from a user-specified location to the origin airport, before being loaded onto the flight and flown to the destination airport. Thus, a bag may be collected from a pick-up location and delivered to a further terminal location or in other words the origin, departure airport.

These embodiments are also compatible with the embodiments discussed previously, such that the passenger's bag can also be delivered from the destination airport to the final destination.

In summary, the passenger 301 sends a request to use the bag delivery service 303 via the mobile application as discussed with reference to previous embodiments. Preferably, the passenger 301 then provides flight details such as a flight number, a full name of the passenger 301, and a pick-up location, but could also provide additional details such as a booking reference or picture of the passenger's bag. This information could be entered manually by the passenger 301 or retrieved automatically from a booking engine. The request is then used to search a database to ensure that the origin and destination airports are compatible with the bag delivery service. Then, a courier service database is searched to ensure a courier can transport the bag from the pick-up to the origin airport. Once these checks are completed, the bag delivery service 303 responds to the request by asking the passenger 301 to confirm the booking of the service. When the passenger 301 confirms the request, the courier service database is used to identify a second courier to be contacted, and a request is then sent from the bag delivery service 303 to the second courier, instructing the second courier to pick up the bag from the pick-up location originally specified by the passenger 301. The details the passenger 301 provides in the request are either used to match-up with an existing booking for a bag on a flight, or are used to book a bag on a flight. The courier subsequently picks up the bag, and delivers it to the origin airport, preferably at an alternative drop-off location. The bag is either tagged by the courier, the passenger, or at the origin airport with a licence plate number (LPN), corresponding to the flight booking.

Thus, it will be appreciated that applying a bag tag to a particular bag may be performed happen at the pickup, at passenger's home, for instance. A connection to the airline's DCS may be required and this may be achieved by using a portable communication device with a bag tag printer. This portable communication device is usually configured with wired or wireless communication with the airline system 254 shown in FIG. 2. The bag tag is then printed and the bag is tagged according to the bag details of the passenger stored the bag system 304, including the LPN details. These details may be retrieved from the airline system 254 in response to a query by the portable communication device. The query may retrieve the relevant bag tag data by sending a query including a passenger's name, or/and booking reference or/and date so that a particular booking and the relevant bag tag data may be retrieved.

The bag is then taken through the relevant security procedures at the origin airport before being loaded onto the same flight as the passenger. The passenger may select the final destination at the same time as booking the pick-up to origin airport journey, or alternatively, may book the journey to the final destination from the destination airport separately. These additional features will now be described in detail below.

Firstly, when the passenger 301 uses the mobile application 302 as described previously to select the bag delivery service, the mobile application may additionally, or alternatively to requesting a bag receipt, request that the passenger 301 provide details of a flight which they have booked. The details also include a pick-up location, which may be the passenger's location, determined by the mobile application 302 or a location specified by the passenger 301. These details may be automatically extracted by the mobile application 302 if the passenger 301 booked the flight on the mobile application 302 or on a booking engine. Alternatively, the passenger 301 may enter the details manually. The details may further include a digital image of the passenger's bag to be delivered, or descriptors for the bag, such as the colour and dimensions of the bag.

Once the passenger 301 has provided the details and the request, the mobile application 302 then sends a Service_Availability request 314, as defined previously, to the Bag Delivery Service 303 including the details of the flight, the bag, the pick-up location and the full passenger name, which may be from passenger authorisation or manually entered by the passenger.

An example service availability request according to this embodiment is provided below as a uniform resource identifier (URI).
Service Availability request:
https://virtserver.swaggerhub.com/1.0.0/Ground_Bag_Delivery/Service_Availability?Passen ger_First_Name=John&Passenger_Last_Name=Doo&Bag details& Pick-up-location==London

The Bag Delivery Service 303 extracts passenger related data from the bag details as before. The Bag Delivery Service 303 may establish whether the origin airport as well as the destination airport can provide the requested service and whether the relevant airline for which the flight is booked has approved the requested service for use by, for example, consulting data associated with the requested origin and destination airport and airline in a database such as the airport database 224.

The bag delivery service 303 then contacts a second courier company to verify the availability and price of a service to transport the bag from the pick-up location to the origin airport, based on the flight departure time and the distance from the pick-up location to the origin airport.

If the second courier company is available to transport the bag to the origin airport, the Bag Delivery Service API 303 then sends the Service_availability API response 322 to the mobile application. For instance, the service availability response including the retrieved bag status data for FIG. 3 may be as follows:

```
Service Availability response:
{
  “Service_available_at_origin and destination airport”: true,
  “Service_Availability_ID”: 123123123,
  “Origin_Airport”: “LGW”,
  “Destination_Airport”: “BCN”,
  “Estimated_Bag_Arrival_Date_and_Time”: 1523699738,
  “Flight_Number”: “U21401”
}
```

The mobile application displays a notification 323 to the user that the delivery service is available and requests the user to confirm the booking. At this point, the user may also enter a final destination address for transport of the bag after it reaches the destination airport. However, this information may be inputted at a later time. The mobile application may also store the Service Availability ID for later use if the user decides to order the service.

The passenger 401 may then choose to go ahead and order the bag delivery service. The mobile application 402 then sends Service_Order API request 411 to the Bag Delivery Service API 403. This request may include the Service_Availability_ID previously provided to the mobile application 402 by the Bag Delivery Service API 403 during the service availability enquiry described above. The Service_Availability_ID is associated with bag information retrieved during the service enquiry process. The Service_Availability_ID may also be associated with the pick-up location for the bag.

An example Service Order request is provided below as a uniform resource identifier (URI).
Service Order request:
https://virtserver.swaggerhub.com/1.0.0/Ground_Bag_Delivery/Service_Order?Pick_up_Ad dress=London&SW1XXX&UK&Service_Availability ID=123123123

As before, the above URI contains a character string used to identify a resource and may include data associated with a scheme, an authority, a system path, and a query. The scheme and authority are unchanged from the Service Availability request detailed above. The system path is mostly unchanged, but refers to a Service Order request rather than a Service Availability request. The query of the above example includes data relating to the pick-up location address and the earlier issued Service Availability ID, “123123123”. The pick-up location is London SW1XXX.

The Bag Delivery Service 303 contacts the bag system 304 to either assign a bag LPN to the bag database 252, or match-up the bag details to an existing LPN, using the corresponding flight and passenger details to identify the correct LPN. Related bag information may also be recorded to the bag system 304, including the total number of bags, and flight information. For instance, the bag information recorded to the bag system may include:
Bag LPN: 123456
Flight: U21401
Origin: LGW
Destination: BCN
Pick-up: LONDON SW1-XXX

In this example, the origin airport is London Gatwick and the destination airport is Barcelona. The pick-up location is London, SW1-XXX. The bag system API 304 then returns the bag details as an API response 320 to the Bag Delivery Service API 303.

In an embodiment, the Bag Delivery Service API 403 sends a BRS_Order API request 412 to a second Baggage Reconciliation System (BRS) notifying the second BRS that the bag associated with a particular LPN, for example LPN “123456”, should be received at an alternative baggage reception point, such as an automated check-in point 113. The Bag Delivery Service API 403 may also send a Courier_Order API request 413 to the Courier Company System 405 of at least one courier delivery company.

An example Courier Order request is shown below.
Courier Order request
curl-X POST
“https://virtserver.swaggerhub.com/1.0.0/Courier_Company/Courier_Order”-H “accept: */*”-H “Content-Type: application/json”-d {“Bag_License_Plate_Number”: 123456, “Pickup_Location”:“London SW1XXX”,“Destination”:“LGW Airport” Order_ID”:123123,“Passenger_First_Name”:“John”, “Passenger_Last_Name”:“Doo”,“Estimated Bag C ollection_Time”: 1523719365.

Similarly to previous requests, the Courier Order request includes the URI for requesting the courier order. In addition, the request includes data associated with the bag to be collected and the delivery details to the origin airport.

In some embodiments, the estimated collection time may be calculated based on the scheduled or estimated flight departure time in combination with an estimated loading time for the airport to load the bag on the plane from the reception point. In such embodiments, the Bag Delivery Service 220 may store the scheduled and estimated times in a database, such as delivery time database 225. In an alternative embodiment, the estimated delivery time may be based on live tracking data stored in a database of the Baggage System 408, such as Bag Database 252.

In response to receiving the Courier_Order request, the Courier Company System 405 may send a notification 414 to the Bag Delivery Service API 403 confirming whether they are able to provide the bag delivery service. A confirmatory notification is shown in the example response below.
Courier Order Response:
status: 200, 200 OK

The data received from the Courier_Order request may be stored in the Active Orders Database 244 or the Queued Orders Database 245 depending on whether the second Courier Company is able to provide the service. The Queued Orders Database 245 for courier journeys between various pick-up locations and the origin airport may be organised according to a First-In-First-Out (FIFO) priority scheme, or alternatively, priority is given to orders corresponding to flights which have the nearest departure time. In other words, an order for a courier for a bag to be on a flight at 10:20 PM should be given priority over a flight at 11:00 PM, if the present time is 8:00 PM.

Finally, the Bag Delivery Service API 403 also sends a Bag_Tracking_System_Update_Receiver API request 415 to the Airline System 406 of the airline responsible for the passenger's bag, notifying the airline that the specified bag will be re-routed through the origin airport via the alternative reception point.

Provided that the passenger has confirmed that they wish to use the bag delivery service, the second courier collects the bag from the user-specified location, and transports the bag to the origin airport. In some embodiments, the second courier is able to print or otherwise affix an LPN bag tag to the bag upon collection from the pick-up point, as previously described in relation to the courier using a portable communication device to retrieve bag tag data from an airline system 254 and print a bag tag.

Alternatively, the passenger 301 affixes a temporary bag tag, and/or the LPN bag tag is affixed at the origin airport.

Once the second courier has collected the bag, a notification is sent to the Bag Delivery Service API 403 as a Courier_Update API notification. The notification confirms that the bag has been collected. In some embodiments, the notification may also include an estimated delivery time from the pick-up location to the origin airport.

As before, the passenger 301 may receive updates regarding the progress of the second courier.

Once the second courier confirms that the passenger's bag is delivered to the origin airport, the Courier Company System 405 sends a Courier_Update API notification 426 to the Bag Delivery Service API 403. In an embodiment, the Bag Delivery Service API 403 sends Bag_Tracking_System_Update_Receiver API notification 427 to the Airline System 406. In a similar manner as above, the Bag Delivery Service API 403 forwards the information included in API notification 426 to the mobile application as App_Order_Update API notification 428 confirming the exact delivery time. In turn, the mobile application displays a notification 429 to the passenger 401 confirming the bag was delivered. For example, the notification may state: “Your bag was successfully delivered to the origin airport!”

At the origin airport, the second courier may drop the bag at a predetermined location, which may be the alternative reception point. From there the bag may be tagged according to the bag details on the bag system 304, including the LPN details and the like. The bag may then go through security checks and other relevant airport procedures before being loaded onto the flight corresponding to the bag details.

In another embodiment, the second courier may be an unmanned vehicle such as a drone. The unmanned vehicle may be controlled by a remote controller, such as a human at a control desk, or the unmanned vehicle may be automated such as an autonomous drone, car or other vehicle.

The passenger may select the final destination for the bag at the same time as they select the pick-up location and place an order for the bag delivery service. Alternatively, the passenger may select a final destination after ordering the bag delivery service for the pick-up location. Therefore, the bag may be in transit anywhere between the pick-up location and the destination airport before the passenger selects the final destination for the bag according to the embodiments discussed above.

Furthermore, in some embodiments, the bag is loaded onto a flight that is different from the one on which the passenger travels, but has the same origin and destination airports, subject to normal security procedures. This may relieve weight and space restrictions if for instance, the bag could be added to a less-busy flight.

This additional feature described here allows the bag of the passenger to be picked up from a user-specified location such as the user's home or office and transported, preferably separate and simultaneously to the passenger, to a final destination specified by the passenger. It is to be understood that this embodiment is not limited to flight as the means of transportation, but may also be incorporated in similar systems concerning shipping and railways. In these embodiments, the origin and destination airports may be any kind of origin and destination terminals, such as an airport, port, train station or the like.

The above detailed description of embodiments of the invention are not intended to be exhaustive or to limit the invention to the precise form disclosed. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure.

1. (canceled)

2. A bag delivery service comprising:
a processor configured to receive information associated with a bag and a customer request to re-route the bag, the customer request including a final destination;
a verification module for performing a verification check based on the customer request to determine a bag delivery service availability; and
based on the bag delivery service availability, the processor is further configured to:
i) send a bag routing request to a baggage sortation system such that the bag is re-routed from a first destination to a collection point, and
ii) send a delivery request including the collection point and the final destination to a delivery service provider such that the bag is collected from the collection point and delivered to the final destination.

3. The bag delivery service of claim 2, wherein the verification check further comprises verifying whether a customer name contained in the information associated with the bag matches a customer name contained in the customer request.

4. The bag delivery service of claim 2, wherein the verification check further comprises determining a delivery service provider availability.

5. The bag delivery service of claim 2, wherein the first destination and the collection point are located in a destination airport.

6. The bag delivery service of claim 2, wherein the first destination is located in a departure country and the collection point is located in a departure airport.

7. A bag delivery system comprising:
a receiver;
a transmitter; and
a bag delivery service comprising:
a processor configured to receive information associated with a bag and a customer request to re-route the bag, the customer request including a final destination;
a verification module for performing a verification check based on the customer request to determine a bag delivery service availability;
based on the bag delivery service availability, the processor is further configured to:
i) send a bag routing request to a baggage sortation system such that the bag is re-routed from a first destination to a collection point, and
ii) send a delivery request including the collection point and the final destination to a delivery service provider such that the bag is collected from the collection point and delivered to the final destination.

8. The bag delivery system of claim 7, further comprising an optical scanner for obtaining the information associated with the bag and/or customer-related information.

9. The bag delivery system of claim 7, further comprising obtaining the information associated with the bag from a bag database.

10. The bag delivery system of claim 7, further comprising a bag tracking service for providing bag location information wherein the bag tracking service is a flight tracker or a baggage tracker.

11. The bag delivery system of claim 7, further comprising a mobile device for providing a notification to the customer that confirms a delivery service order, or confirms that the bag has been delivered to the final destination.

12. The bag delivery system of claim 7, further comprising a delivery time database that stores at least one of weather information, time information, and flight operator information for estimating a bag delivery time.

13. The bag delivery system of claim 7, further comprising a delivery time database that stores historical data regarding how long it took to deliver a previous bag, wherein the system is further configured to predict a delivery time of the bag based at least in part on the historical data.

14. The bag delivery system of claim 7, further comprising an availability engine configured to perform the verification check for determining a delivery service provider availability.

15. The bag delivery system of claim 7, further comprising a queued orders database wherein the verification check for determining a delivery service provider availability is based on the number of queued orders stored in the queued orders database.

16. A bag delivery method comprising the steps of:
receiving information associated with a bag and a customer request to re-route the bag, the customer request including a final destination;
performing a verification check based on the customer request to determine a bag delivery service availability; and
if the bag delivery service is available, sending a bag routing request to a baggage sortation system such that the bag is re-routed from a first destination to a collection point; and sending a delivery request including the collection point and the final destination to a delivery service provider such that the bag is collected from the collection point and delivered to the final destination.

17. The bag delivery service of claim 16, wherein the verification check further comprises determining a delivery service provider availability with an availability engine and/or a queued orders database.

18. The method of claim 16, further comprising querying legacy systems to obtain the information associated with the bag.

19. The bag delivery method of claim 16, further comprising the step of notifying a customer associated with the bag that the bag has been delivered to the final destination.

20. The bag delivery method of claim 16, further comprising the step of receiving bag location information from a bag tracking service.

21. The bag delivery method of claim 16, further comprising the step of estimating a bag delivery time based, at least in part, on one or more of: weather information; time information; flight operator information; and historical data regarding how long it took to deliver a previous bag.
